(19) United States
(12) Patent Application Publication
(10) Pub. No.: US 2010/0059565 A1
(43) Pub. Date: Mar. 11, 2010

(54) AERODYNAMIC HANDS FREE LIQUID CONTAINER FOR BICYCLES

(75) Inventor: Mark Cote, Boston, MA (US)

Correspondence Address: MICHAEL BEST & FRIEDRICH LLP, 100 E WISCONSIN AVENUE, Suite 3300, MILWAUKEE, WI, 53202, US

(73) Assignee: SPECIALIZED BICYCLE COMPONENTS, INC., Morgan Hill, CA (US)

(21) Appl. No.: 12/303,237

(22) PCT Filed: Jun. 4, 2007
(86) PCT No.: PCT/US07/70324

§ 371 Date: Jul. 2, 2009

Related U.S. Application Data
(60) Provisional application No. 60/810,311, filed on Jun. 2, 2006.

(51) Int. Cl. B62J 9/00; B62J 11/00

(52) U.S. Cl. 224/414; 224/425; 224/463; 220/705

(57) ABSTRACT

An aerodynamic liquid carrying container adapted for liquid delivery to a cyclist includes a reservoir with at least one compartment adapted to hold a liquid and being mountable to a bicycle forward frame member. The reservoir has at least one opening, to receive liquid and to allow liquid to be drawn out from the container; a flexible tubing member passing from the inside to the outside of the reservoir and having a first and second ends, the first end located near the lowest liquid level point in the reservoir and the second end being positionable to allow a rider hands-free access to drink liquid contained in the reservoir; furthermore, the container is attached to the frame member(s) using pads, suction cups, VELCRO®, or straps that do not leave a mark on the frame member(s). The container is mounted in a zone of turbulence to increase the aerodynamic performances of a bicycle.

### CROSS REFERENCE TO RELATED APPLICATIONS

The present invention claims priority to U.S. Provisional Patent Application Ser. No. 60/810,311 entitled Aerodynamic Hands Free Liquid Container For Bicycles and The Like which was filed on Jun. 2, 2006 and which is hereby incorporated by reference.

### FIELD OF INVENTION

The present invention relates generally to the field of bicycle accessories and more specifically to an aerodynamic bicycle mounted fluid container.

### BACKGROUND OF INVENTION

Several liquid delivery systems for cyclists are well known including a removable bottle and cage mounted on a bicycle frame member, a reservoir adapted for attachment to a bicycle saddle rails or seatpost, a reservoir carried on a bicycle rider's back with a tube extending in front of the rider's face, and several pressurized and non-pressurized frame member liquid delivery systems.

Although the heretofore known liquid delivery systems have sufficed to provide liquid carrying and delivery for cyclists, many of the needs of enthusiasts, elite cyclists, mountain bicyclists, triathletes, and others seeking an aerodynamic design have not been addressed. These cyclists would benefit from a system that allows easy and continuous access to fluids without taking their hands off the handlebars or taking their eyes away from the road. It is desirable to provide an ability to refill the reservoir with another liquid source while riding, and to provide enhanced aerodynamic performance due to the design and placement of the reservoir. Given the cost of many of today's bicycles and the use of carbon fiber frames, it is desirable to provide a mounting system that is aerodynamic and does not leave a mark on the frame.

Bicycles are no longer constructed with frames of just cylindrical tubes. Several of today's elite bicycles have aerodynamically and structurally optimized frame members with varying cross sectional shapes. Therefore, there exists a need for a system that easily mounts on several different types of bicycles.

U.S. Pat. Nos. 5,115,952 (Jenkins) and 5,788,134 (Matic, Jr.) disclose frame member mounted fluid carrying systems that satisfy many of these needs. These systems do not allow easy refill and are not aerodynamically optimized either in term of their shapes or their attachment methods. Furthermore, their attachment methods can mark the frame.

U.S. Pat. No. 5,215,231 (Paczonay) discloses a reservoir mounted to a frame member with a tube that runs along a cyclist's back. This system keeps the cyclist attached to the reservoir and does not allow for the cyclist to easily mount and dismount the bicycle as is required in sports such as triathlon competitions.

U.S. Pat. No. 4,441,638 (Shimano) discloses an aerodynamically shaped water bottle and cage adapted for mounting on a frame member. This system still requires the rider to take his or her hand off of the handlebars to reach for the bottle. Doing so can cause in instability while riding, resulting in a crash causing injury or even death. Furthermore, the attachment methods can mark the frame.

Previously known fluid carrying systems devices have also used pressurized reservoirs. These systems also require a rider to interact with the system while riding, causing safety hazard. U.S. Pat. No. 5,143,390 (Goldsmith), for example, discloses a pressurized bottle that includes several elements that require communication with the rider.

U.S. Pat. No. 6,953,135 (Litton et al.) discloses a refill system that accepts commercially available bottles to refill a reservoir mounted below a bicycle seat. This system addresses many of the needs of an elite level cyclist or triathlete. However, wind tunnel tests suggest that this system provides poor aerodynamic performance because it increases the total aerodynamic drag as compared to a bicycle and rider alone.

Thus, there exists a need for a fluid carrying and delivery system that accommodates the needs of an elite level cyclist while addressing the safety concerns of recreational cyclists.

### SUMMARY OF THE PRESENT INVENTION

An illustrative embodiment of the invention provides an aerodynamic, hands free liquid container for mounting to a bicycle frame member. An embodiment of the container has rounded ends and a bottom portion that makes contact with a bicycle frame member and or mounting brackets. One end of the container is located closely behind the trailing edge of the bicycle's steering axis so the reservoir occupies a space that, but for the presence of the reservoir, is a turbulent wake region caused by the bicycle's head tube, steerer tube, handle bars and/or stem. In an illustrative embodiment the leading end of the container is located between about 0 cm and about 10 cm behind the trailing edge of the steering axis members. The presence of the inventive reservoir eliminates much of the turbulent wake in this region and reduces the aerodynamic drag on the bicycle.

The reservoir can be held in place by attachment elements such as straps, VELCRO®, zip ties, pipe clamps, or the like. In one embodiment, the front end portion is rounded and larger than the rear end portion. The container can be mounted to the top of the bicycle top tube directly behind the stem and handlebars for easy filling access and for providing an improved aerodynamic effect.

The container includes an opening for filling the container and another opening for receiving a flexible drinking tube. In an illustrative embodiment, the opening for filling the container can be closed with a removable cover.

### BRIEF DESCRIPTION OF THE DRAWINGS

The foregoing and other features and advantages of the present invention will be better understood from the following detailed description of illustrative embodiments, taken in conjunction with the accompanying drawings in which:

FIG. 1 is a side view showing a liquid carrying reservoir mounted on the top frame member of a bicycle according to an illustrative embodiment of the invention;

FIG. 2 is a cross sectional view of a liquid carrying reservoir mounted to a frame member of a bicycle showing the level liquid line and relative placement of a flexible tubing member according to an illustrative embodiment of the invention;

FIG. 3 is a front cross sectional view of a reservoir showing attachment elements for mounting the device on a frame member of a bicycle according to an illustrative embodiment of the invention;

FIG. 4 is a top view of a reservoir showing the aerodynamic profile according to an illustrative embodiment of the invention;

FIG. 5a is a top view of fluid flow around a cylinder representing a bicycle steering column frame members at racing speeds showing the wake region formed without the aerodynamic benefit of the reservoir according an illustrative embodiment of the invention; and

FIG. 5b is a top view of fluid flow around a cylinder representing a bicycle steering column frame member showing reattachment of airflow onto the fluid container.

### DETAILED DESCRIPTION

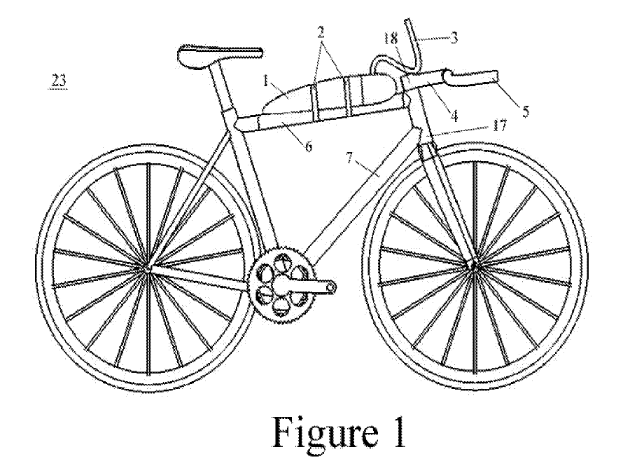

FIG. 1 illustrates a conventional bicycle 23 which is made up of several frame members including an upper forward frame member 6, commonly known as a top tube and a lower forward frame member 7, commonly known as a down tube, attached to a vertical frame member 17 commonly known as a head-tube tube. Protruding vertically from the head-tube 17 is a steerer tube 18 which is attached to handlebars 5 via stem 4 for steering the bicycle. Although the frame members are commonly referred to as “tubes,” persons having ordinary skill in the art should understand that they are not necessarily tubular in cross-section. Rather, modern bicycles made from composite materials are known to have frame members with varying cross sectional shapes and dimensions.

An illustrative embodiment of a reservoir according to the present invention is adapted for mounting either on the top tube 6 or the down tube 7 of a bicycle. In FIG. 1, a reservoir 1 is mounted atop the top tube 6 using VELCRO® VELCRO® straps 2. Persons having ordinary skill in the art should understand that the use of VELCRO® straps 2 is shown as an example and that a variety of attachment elements may be used such as clamps, buckled straps or the like within the scope of the present invention. In an illustrative embodiment, the reservoir housing is recessed to accept the mounting straps such that the mounting straps are approximately flush with the outer surface of the housing. The base of the reservoir 1 is illustratively covered with a thin, compliant, high-friction rubber that provides a gripping interface between the reservoir 13 and top tube 6. When the VELCRO® straps 2 are tightened down over the reservoir 3 and around the top tube 6, the rubber is compressed and a normal force increases the torsional interaction between the reservoir 1 and the top tube 6. The VELCRO® straps 2 may also be lined with rubber for the contact area they have with the top tube 6. This attachment system could also be implemented with VELCRO® on the base of the reservoir 13 and top of the top tube 6.

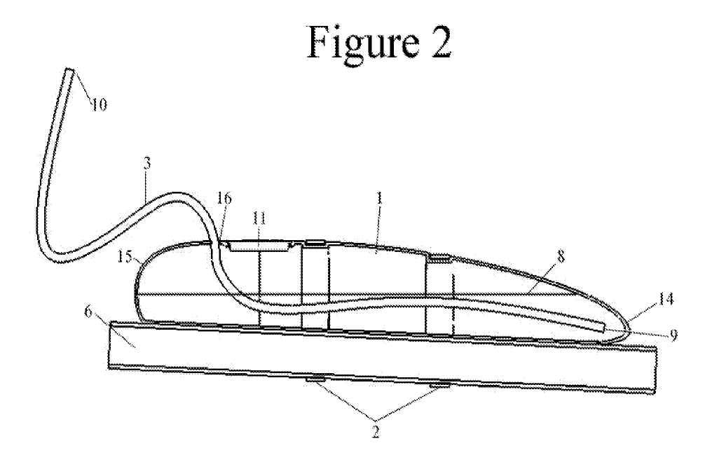

FIG. 2 shows a length-wise cross section of the reservoir 1 mounted atop the top tube 6 using the VELCRO® straps 2. The reservoir has a curved leading edge 15 and an external surface which tapers to a trailing edge 14. In an illustrative embodiment, the reservoir has a width (W) of between about 3 cm and about 12 cm and a length (L) of between about 5 cm to about 60 cm. A flexible drinking tube 3 having a first end 10 and a second end 9 extends through a first opening 16 in the reservoir 1. Illustrative embodiment of the invention include a drinking tube 3 which is positionable by the rider and may include a mouthpiece, and/or means to secure the drinking tube to the bicycle. A cap 11 covers a second opening which is provided to add liquid to the reservoir 1. The second opening is illustratively recessed so that the cap 11 sits approximately flush or below flush with the top surface of the reservoir. It is envisioned that other or cap or valve designs could be implemented to allow for the ability to refill the reservoir 1 while riding, for example, within the scope of the present invention. In one embodiment, the cap comprises an orifice that releases pressure from the reservoir while a negative pressure is being exerted on the drinking tube and the reservoir. In another embodiment the cap comprises a compliant valve that is adapted for accepting a commercially available drink container bottle for efficient filling of the reservoir. A fluid level line 8 is shown relative to the drinking tube second end 9 to illustrate that the second end 9 is preferably located toward the trailing edge of the reservoir where the last volume of fluid will gather as the reservoir empties.

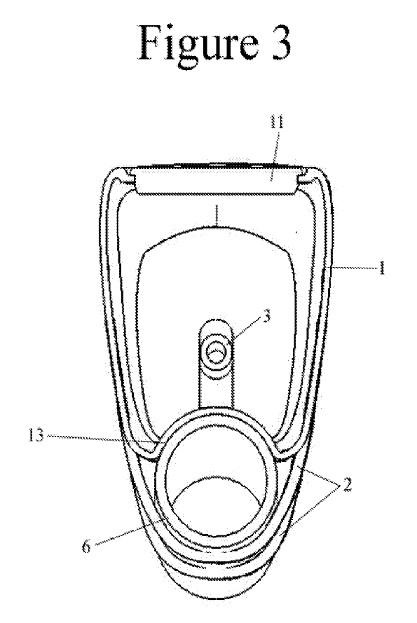

FIG. 3 shows a concave lower surface of the reservoir 13. In an illustrative embodiment, the depth of the concave lower surface 13 is tapered to be deeper at the leading edge 15 than the trailing edge 14. The reasons for this are two fold. First, more liquid volume is held in the larger part of the reservoir 1 which is supported by the greater surface area contact between the base of the reservoir 1 and the top tube 6. Secondly, conventional road racing bicycles have either horizontal top frame members (top tubes) or slight sloping frame members that are higher near the front of the bicycle 22. An illustrative embodiment of the present invention takes this into account so the lowest point in the reservoir 1 is close to the trailing edge 14. Thus the placement of the second end 9 of the flexible tubing member 3 is below the level fluid line 8.

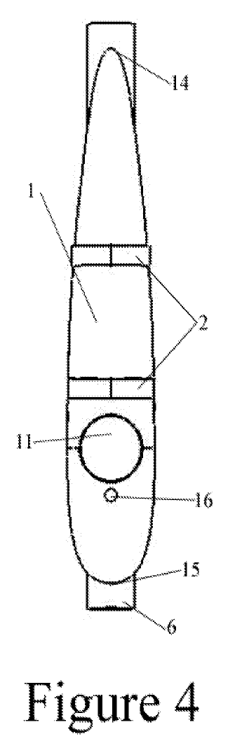

FIG. 4 is a top view showing the reservoir 1 including the leading edge 15 and trailing edge 14 and being mounted by VELCRO® straps 2 to a top tube 6. First opening 16 and the cap 11 covering the second opening are shown.

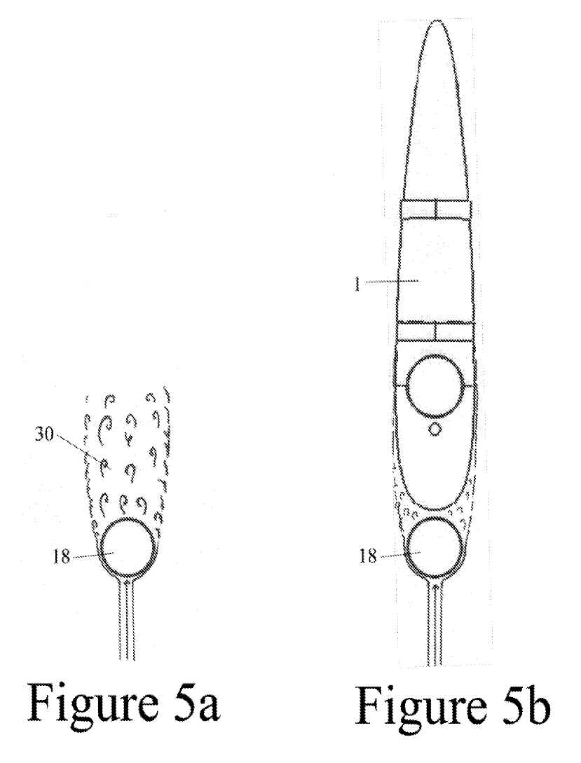

FIG. 5a shows a wake region 30 generated behind a tubular member representative of a bicycle head-tube 17 and/or steerer tube 18 as it passes through the air at a typical racing speed. The wake region 30 is a volume of turbulent air directly behind the tubular member. This wake region causes drag which slows the bicycle or requires increased rider effort to maintain speed. The free stream air in front of the handlebars 5 and stem 4 separates from the obstructing surfaces (steerer tube, handlebars) and becomes turbulent flows with Reynolds Numbers between 3×10̂3 and 3×10̂5 around a typical steering column. This airflow regime is typical for typical riding speeds, ambient wind speeds, and bicycle designs. This wake region continues downstream of the obstruction for several diameters or the tubular member. Empirical measurements in a wind tunnel have shown the turbulent wake to still exist 15 centimeters downstream of a 25.4 millimeter diameter steerer column. Airflow around steerer columns of larger diameters would cause turbulent wakes to continue proportionately farther downstream.

It is aerodynamically efficient to fill this wake region with a rigid volume, as shown in the illustrative embodiment of FIG. 5b. In the illustrative embodiment shown in FIG. 5b, a fluid reservoir 1 is mounted on top of the top tube 6 directly behind a steerer 18 and stem 4. Placing the inventive rigid aerodynamic reservoir in this region causes no additional drag on the bicycle. This effectively hides the reservoir from laminar freestream flow. In an illustrative embodiment, the aerodynamically shaped reservoir causes the separated airflow to reattach to it thereby effectively decreasing the size of the turbulent wake region. The reservoir is shaped to taper slowly on the trailing edge allowing the airflow to remain attached to the surface. Doing so proportionally decreases the size of the low-pressure region behind the steerer and in turn decreases the pressure drag. This provides the dual benefit of reducing the bicycle's aerodynamic drag while proving a fluid container that does not itself increase drag. Thus, the inclusion of an aerodynamically optimized reservoir 1 is, as the present invention suggests, aerodynamically superior to a bicycle without the reservoir.

In an illustrative embodiment, the reservoir 1 is designed to be manufactured using extrusion blow molding. Persons having ordinary skill in the art should understand that a variety of other manufacturing methods such as multi-component thermoplastic molding, carbon fiber manufacturing techniques and the like can be used within the scope of the invention. High or low-density polyethylene, polypropylene, or polycarbonate or a variety of other polymers or other materials could be used to manufacture the inventive container depending upon the desired material properties. Illustrative embodiments of the invention include a reservoir having a UV coating to protect it from material degradation over time, and/or a reflective coating or the like to reflect radiative heat and sunlight for keeping contents of the reservoir cool.

While the invention has been described with reference to an exemplary embodiment, it should be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A container for a bicycle comprising:
a compartment enclosed by an aerodynamic housing;
wherein the compartment is adapted to occupy a region immediately aft of a turbulence inducing member of the bicycle and reducing a turbulent wake of the turbulence inducing member.

2. The container of claim 1 comprising:
at least one mounting surface in contact with the bicycle; and
at least one mounting element adapted for securing the container to a forward frame member of the bicycle.

3. The container of claim 1, comprising:
a reservoir adapted to hold a liquid;
a first opening for filling the reservoir;
a second opening for withdrawing fluid from the reservoir; and
a drinking tube extending through the second opening, the drinking tube having a first and second end, wherein the first end is located in the container, and the second end is located outside the container.

4. The container of claim 3 wherein the drinking tube is positionable by the rider for hands free access.

5. The container of claim 1 wherein the aerodynamic shape has a rounded front end and a rounded back end wherein the front end is larger than the back end.

6. The container of claim 3 with a curved underside to make contact with the frame member.

7. The container of claim 2, wherein the at least one mounting element comprises:
at least one adjustable length strap that wraps around the bicycle frame member to secure the container to the bicycle

8. The container of claim 4 with at least one recessed region of for receiving the strap(s) such that the straps are approximately flush with the housing.

9. The container of claim 2 wherein the at least one mounting element comprises: “VELCRO®” attached to the mounting surface and mating “VELCRO®” adhesively attached to the forward frame member.

10. The container of claim 1 wherein the housing has a maximum width approximately equal to the width of a wake region defined by an zone of aerodynamic turbulence created aft of a steering axis of the bicycle at a typical riding speed when the reservoir is not installed.

11. The container of claim 10 wherein the reservoir has a width of between about 3 cm and about 12 cm and a length of between about 5 cm to about 60 cm.

12. The container of claim 1 wherein the at least one mounting member comprising at least one mounting bracket with mounts to the forward frame member(s).

13. The container of claim 1, further comprising a cut-out on the housing to allow the housing to partially envelop a frame member of the bicycle when mounted thereto.

14. The container of claim 1, wherein the housing has an aerodynamic profile that has a maximum width in a front half of the housing and tapers to a smaller width toward a rear end of the housing.

15. The container of claim 3, further comprising means to secure the flexible tubing member to a handlebar, stem, or forward frame member(s) of the bicycle.

16. The container of claim 3, further comprising a cap which covers the first opening.

17. The container of claim 3, further comprising a compliant valve allowing for liquid delivery into the reservoir through an orifice but limiting the escape of the liquid through the orifice.

18. A container of claim 3 further comprising an orifice that allows for the release of pressure from the reservoir while a negative pressure is being exerted on the drinking tube and the reservoir.

19. The container of claim 17 wherein the valve is adapted to receive a commercially available liquid bottle to deliver the liquid into the reservoir.

20. The container of claim 3, further comprising a mouthpiece attached to the second end of the drinking tube.

21. The container according to claim 1 wherein the housing includes a plurality of compartments, wherein at least one compartment comprises a reservoir adapted to hold a liquid.

22. A method for reducing aerodynamic drag on a bicycle, the method comprising:
mounting an aerodynamic housing in a region aft of a forward turbulent wake inducing portion of the bicycle, the housing being accessible by a rider of the bicycle and adapted for carrying a drinking fluid;
wherein the housing is adapted to substantially eliminate a turbulent wake caused by the turbulent wake inducing portion in the region.
